(19) United States
(12) Patent Application Publication
(10) Pub. No.: US 2023/0180338 A1
(43) Pub. Date: Jun. 8, 2023

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/164,533

(22) Filed: Feb. 3, 2023

Related U.S. Application Data
(63) Continuation of application No. PCT/JP2021/029111, filed on Aug. 5, 2021.

(30) Foreign Application Priority Data
Aug. 6, 2020 (JP) 2020-133859

(51) Int. Cl. H04W 76/20; H04W 74/08

(52) U.S. Cl. CPC H04W 76/20; H04W 74/0833

(57) ABSTRACT

In an embodiment, a communication control method is a communication control method in a mobile communication system including a user equipment and a base station apparatus, in which wireless communication is performed between the user equipment and the base station apparatus. The communication control method includes transmitting, by the user equipment in a Radio Resource Control (RRC) connected state, first preference information to the base station apparatus, and receiving, by the base station apparatus, the first preference information. The first preference information is information indicating that the user equipment in an RRC inactive state desires to perform transmission of data by using a message of a random access procedure and/or transmission of the data by using a preconfigured radio resource.

### RELATED APPLICATIONS

The present application is a continuation based on PCT Application No. PCT/JP2021/029111, filed on Aug. 5, 2021, which claims the benefit of Japanese Patent Application No. 2020-133859 filed on Aug. 6, 2020. The content of which is incorporated by reference herein in their entirety.

### TECHNICAL FIELD

The present disclosure relates to a communication control method used in a mobile communication system.

### BACKGROUND OF INVENTION

In the Third Generation Partnership Project (3GPP), which is a standardization project for mobile communication systems, early data transmission (EDT) has been defined in which transmission and reception of data is performed during a random access procedure (for example, see NPL 1).

EDT includes Mobile Originated-EDT (MO-EDT) and Mobile Terminated-EDT (MT-EDT).

MO-EDT is EDT for transmitting uplink data. MO-EDT is started when an upper layer of a user equipment requests establishment or resumption of Radio Resource Control (RRC) connection for user equipment originated data and the size of uplink data becomes a transport block (TB) size indicated by system information or smaller. Note that, in MO-EDT, during the random access procedure, downlink data transmission following the uplink data transmission can also be performed.

In contrast, MT-EDT is EDT for performing downlink data transmission. In MT-EDT, when the user equipment receives a paging message including an MT-EDT command from a base station, the user equipment performs the random access procedure and receives the downlink data from the base station at the timing of receiving downlink data in MO-EDT.

In 3GPP, a Preconfigured Uplink Resource (PUR) is also defined. In the PUR, without performing a random access procedure, uplink transmission is performed in an RRC idle (RRC_IDLE) state by using the preconfigured uplink resource.

The user equipment in an RRC connected (RRC_CONNECTED) state transmits a PUR Configuration Request message to the base station and receives an RRC Connection Release message including the PUR resource from the base station. The RRC connection release message includes information used for PUR configuration, such as resource used for data transmission (which may be hereinafter referred to as “PUR resource”).

The user equipment in the RRC idle state can transmit data to the base station together with an RRC connection resume (RRC Connection Resume Request) message, by using the PUR resource. As an option, the user equipment in the RRC idle state can also receive downlink data together with an RRC Connection Release message after the RRC connection resume message.

### CITATION LIST

### Non-Patent Literature

NPL 1: 3GPP TS 38.300 V16.2.0 (2020 July)

### SUMMARY

In a first aspect, a communication control method is a communication control method in a mobile communication system where wireless communication is performed between a user equipment and a base station apparatus. The communication control method includes transmitting, by the user equipment in a Radio Resource Control (RRC) connected state, first preference information to the base station apparatus, and receiving, by the base station apparatus, the first preference information. The first preference information is information indicating that the user equipment in an RRC inactive state desires to perform first data transmission of transmitting data by using a message of a random access procedure and/or second data transmission of transmitting the data by using a preconfigured radio resource.

In a second aspect, a communication control method is a communication control method in a mobile communication system where wireless communication is performed between a base station apparatus including a first plurality of cells and a user equipment, or between the base station apparatus and a different base station apparatus, which include a second plurality of cells constituted by the base station apparatus and the different base station apparatus each including at least one cell, and the user equipment. The communication control method includes transmitting, by the base station apparatus, configuration information to the user equipment in a Radio Resource Control (RRC) connected state, receiving, by the user equipment in the RRC connected state, the configuration information, and transmitting, by the user equipment in an RRC inactive state, data by using a preconfigured radio resource in the first plurality of cells or the second plurality of cells, based on the configuration information. The configuration information is information for the transmitting, by the user equipment in the RRC inactive state, the data by using the preconfigured radio resource in the first plurality of cells or the second plurality of cells.

In a third aspect, a communication control method is a communication control method in a mobile communication system where wireless communication is performed between a base station apparatus and a user equipment. The communication control method includes transmitting, by the base station apparatus, configuration information to the user equipment in a Radio Resource Control (RRC) connected state, and receiving, by the user equipment in the RRC connected state, the configuration information. The communication control method further includes performing, by the user equipment in an RRC inactive state and by using at least one selected from the group consisting of carrier aggregation, dual connectivity, and Packet Data Convergence Protocol (PDCP) duplication, first data transmission of transmitting data by using a message of a random access procedure and/or second data transmission of transmitting data by using a preconfigured radio resource, based on the configuration information.

In a fourth aspect, a communication control method is a communication control method in a user equipment that performs wireless communication with a base station apparatus. The communication control method includes storing, by the user equipment in a Radio Resource Control (RRC) inactive state and when the user equipment fails in transmission of data by using a message of a random access procedure or transmission of data by using a preconfigured radio resource, information related to failure in a memory of the user equipment, and transmitting, by the user equipment in the RRC inactive state or the user equipment in an RRC connected state, the information related to the failure stored in the memory to a base station apparatus.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment according to an embodiment.

FIG. 3 is a diagram illustrating a configuration of a base station according to an embodiment.

FIG. 4 is a diagram illustrating a configuration example of a protocol stack of a user plane.

FIG. 5 is a diagram illustrating a configuration example of a protocol stack of a control plane.

FIG. 6 is a diagram illustrating an operation example of Example 1.

FIG. 7 is a diagram illustrating an example of UE assistance information.

FIG. 8A is a diagram illustrating an operation example of EDT. FIG. 8B is a diagram illustrating an operation example of PUR.

FIGS. 9A and 9B are diagrams illustrating operation examples using a UE context retrieval message.

FIG. 10 is a diagram illustrating an operation example using a handover request message.

FIG. 11A is a diagram illustrating an example of a case in which two cells are present in one gNB. FIG. 11B is a diagram illustrating an example of a case in which one cell is present in each gNB.

FIGS. 12A and 12B are diagrams illustrating examples of a PUR area.

FIG. 13 is a diagram illustrating an operation example of Example 2.

FIGS. 14A and 14B are diagrams illustrating examples of CA.

FIG. 15A is a diagram illustrating an example of DC. FIG. 15B is a diagram illustrating an example of PDCP duplication.

FIG. 16 is a diagram illustrating an operation example of Example 3.

FIGS. 17A and 17B are diagrams illustrating operation examples of SDT procedure failure.

FIG. 18 is a diagram illustrating an operation example of Example 4.

### DESCRIPTION OF EMBODIMENTS

A mobile communication system according to embodiments will be described with reference to the drawings. In the description of the drawings, the same or similar parts are denoted by the same or similar reference signs.

### Configuration of Mobile Communication System

First, a configuration of a mobile communication system according to an embodiment will be described. While the mobile communication system according to an embodiment is a 3GPP 5G system, Long Term Evolution (LTE) may be at least partially applied to the mobile communication system.

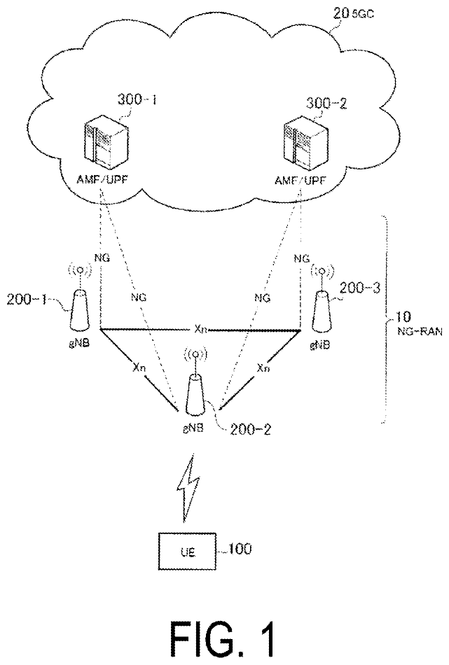

FIG. 1 is a diagram illustrating a configuration of the mobile communication system according to an embodiment.

As illustrated in FIG. 1, the mobile communication system includes a User Equipment (UE) 100, a 5G radio access network (Next Generation Radio Access Network (NG-RAN)) 10, and a 5G Core Network (5GC) 20.

The UE 100 is a mobile apparatus. The UE 100 may be any apparatus as long as the apparatus is used by a user. Examples of the UE 100 include apparatuses that can perform wireless communication, such as a mobile phone terminal (including a smartphone), a tablet terminal, a laptop PC, a communication module (including a communication card or a chip set), a sensor, an apparatus provided on a sensor, a vehicle, an apparatus provided on a vehicle (Vehicle UE), a flying object, and an apparatus provided on a flying object (Aerial UE).

The NG-RAN 10 includes base station apparatuses (referred to as “gNBs” in the 5G system) 200. The gNBs 200 may also be referred to as NG-RAN nodes. The gNBs 200 are interconnected via an Xn interface, which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of wireless communication area. The “cell” is also used as a term representing a function or a resource for performing wireless communication with the UE 100. One cell belongs to one carrier frequency.

Note that the gNB 200 may be connected to an Evolved Packet Core (EPC) which is a core network of LTE, or a base station of LTE may be connected to the 5GC 20. The base station of LTE (referred to as an “eNB” in the LTE system) and the gNB may be connected via the inter-base station interface.

The 5GC 20 includes an Access and Mobility Management Function (AMF) and a User Plane Function (UPF) 300-1 and 300-2. The AMF performs various types of mobility controls and the like for the UE 100. The AMF manages information of an area in which the UE 100 exists by communicating with the UE 100 by using Non-Access Stratum (NAS) signalling. The UPF controls data transfer. The AMF and UPF are connected to the gNB 200 via an NG interface, which is an interface between a base station and the core network.

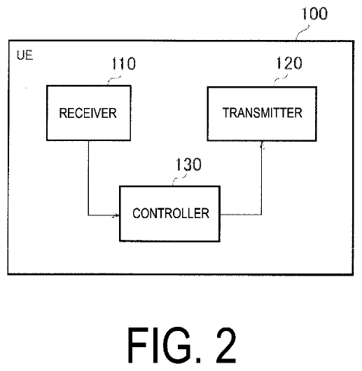

FIG. 2 is a diagram illustrating a configuration of the UE 100 (user equipment) according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts (down-converts) a radio signal received through the antenna into a baseband signal (a received signal) and outputs the resulting signal to the controller 130.

The transmitter 120 performs various types of transmission under control of the controller 130. The transmitter 120 includes an antenna and a transmission device. The transmission device converts (up-converts) a baseband signal output by the controller 130 (a transmission signal) into a radio signal and transmits the resulting signal through the antenna.

The controller 130 performs various types of control in the UE 100. The controller 130 includes at least one processor and at least one memory electrically connected to the processor. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

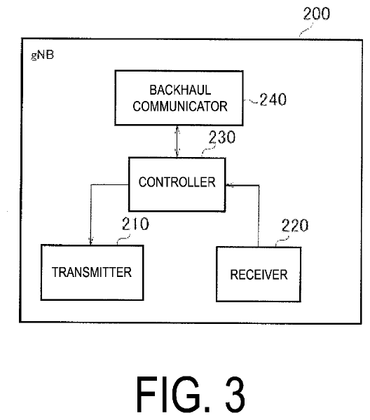

FIG. 3 is a diagram illustrating a configuration of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts (up-converts) a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts (down-converts) a radio signal received through the antenna into a baseband signal (a received signal) and outputs the resulting signal to the controller 230.

The controller 230 performs various types of controls for the gNB 200. The controller 230 includes at least one processor and at least one memory electrically connected to the processor. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The CPU may be replaced by a processor or a controller, such as a digital signal processor (DSP) or a field programmable gate array (FPGA).

The backhaul communicator 240 is connected to a neighboring base station via the inter-base station interface. The backhaul communicator 240 is connected to the AMF/UPF 300-1 and 300-2 via the interface between the base station and the core network. Note that the gNB 200 may include a Central Unit (CU) and a Distributed Unit (DU) (i.e., functions are divided), and the two units may be connected via an F1 interface.

### Protocol Stack

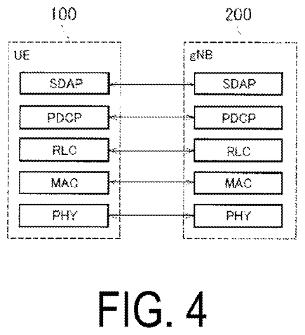

FIG. 4 is a diagram illustrating a configuration of a protocol stack of a radio interface of a user plane that handles data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and antenna demapping, and resource mapping and resource demapping. Data and control information are transmitted between the PHY layer of the UE 100 and the PHY layer of the gNB 200 via a physical channel.

The MAC layer performs priority control of data, retransmission processing by using a hybrid ARQ (HARM), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink, and resource blocks to be allocated to the UE 100.

The RLC layer transmits data to the RLC layer on the reception end by using functions of the MAC layer and the PHY layer. Data and control information are transmitted between the RLC layer of the UE 100 and the RLC layer of the gNB 200 via a logical channel.

The PDCP layer performs header compression and header decompression, and encryption and decryption.

The SDAP layer performs mapping between an IP flow being a unit that a core network performs QoS control and a radio bearer being a unit that an Access Stratum (AS) performs QoS control. Note that, when the RAN is connected to the EPC, the SDAP may not be provided.

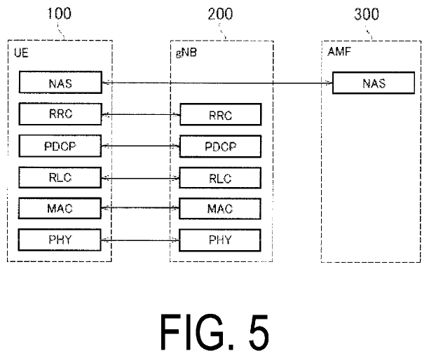

FIG. 5 is a diagram illustrating a configuration of a protocol stack of a radio interface of a control plane that handles signalling (control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signalling for various configurations is transmitted between the RRC layer of the UE 100 and the RRC layer of the gNB 200. The RRC layer controls a logical channel, a transport channel, and a physical channel in response to establishment, reestablishment, and release of a radio bearer. When a connection between the RRC of the UE 100 and the RRC of the gNB 200 (RRC connection) is present, the UE 100 is in an RRC connected state. When a connection between the RRC of the UE 100 and the RRC of the gNB 200 (RRC connection) is not present, the UE 100 is in an RRC idle state. When the RRC connection is suspended, the UE 100 is in an RRC inactive state.

The NAS layer located upper than the RRC layer performs session management, mobility management, and the like. NAS signalling is transmitted between the NAS layer of the UE 100 and the NAS layer of the AMFs 300-1 and 300-2.

Note that the UE 100 includes an application layer other than the protocol of the radio interface.

### EDT

EDT will be described. In the following, an embodiment in which EDT of LTE is introduced into the 5G system (NR) will be described.

In EDT, the UE 100 in the RRC idle state can transmit and receive data by using a message of the random access procedure. As described above, EDT includes MO-EDT and MT-EDT.

In MO-EDT, uplink data transmission is performed. In MO-EDT, during the random access procedure, downlink data transmission following the uplink data transmission can also be performed. When an upper layer of the UE 100 requests establishment or resumption of RRC connection for UE originated (Mobile Originated (MO)) data, and the size of uplink data becomes a transport block (TB) size indicated by system information or smaller, EDT is initiated. In MO-EDT, the UE 100 transmits uplink data by using Msg3 of the random access procedure.

In contrast, in MT-EDT, downlink data transmission is performed. When the UE 100 receives a paging message including a command of MT-EDT from an evolved NodeB (eNB) (LTE base station), the UE 100 executes the random access procedure. Then, the UE 100 can receive the downlink data by using Msg4 of the random access procedure.

EDT has two types, namely User Plane Optimisation and Control Plane Optimisation. In User Plane Optimisation of EDT, user data (DTCH) and an RRC message (CCCH) are multiplexed into one MAC PDU to be transmitted in the MAC layer, without the user data being included in the RRC message. In contrast, in Control Plane Optimisation of EDT, user data is included in an RRC message.

User Plane Optimisation is applicable when the UE 100 is in the RRC inactive state. In the RRC inactive state, context information of the UE 100 is maintained in the gNB 200. In User Plane Optimisation, an RRC message constituting Msg3 corresponds to an RRC Connection Resume Request message, and an RRC message constituting Msg4 corresponds to basically an RRC Connection Release message. When the UE 100 receives the RRC connection release message, the UE 100 completes the random access procedure while maintaining the RRC inactive state. In the present embodiment, description will be given by taking User Plane Optimisation as an example.

### PUR

The PUR is a communication method for performing uplink transmission in the RRC idle state by using a preconfigured uplink radio resource (which may be hereinafter referred to as “PUR resource”), without using the random access procedure. A series of processing operations in the PUR are as follows, for example.

When the UE 100 is in the RRC connected state, the UE 100 transmits a PUR Configuration Request message to the gNB 200. The PUR configuration request message includes the number of PUR occasions, periodicity of the PUR occasion and offset time until a first PUR occasion, a transport block size, and necessity of ACK.

When the gNB 200 receives the PUR configuration request message, the gNB 200 determines to cause the UE 100 to transition to the RRC idle state and supplies the PUR resource for the UE 100. Then, the gNB 200 transmits the RRC Connection Release message to the UE 100. The RRC connection release message includes information representing details of the PUR Configuration, such as the PUR resource.

The UE 100 receives the RRC connection release message, and transitions to the RRC idle state. The UE 100 in the RRC idle state transmits data to the gNB 200 by using the preconfigured uplink resource included in the RRC connection release message. In this case, the UE 100 multiplexes an RRC Connection Request message and uplink data and transmits the multiplexed data to the gNB 200. Note that, in the present embodiment, as will be described below, PUR transmission in the RRC inactive state can be performed. The UE 100 that has transitioned to the RRC inactive state, instead of the above RRC idle state, can also multiplex an RRC Connection Resume Request message and uplink data and can transmit the multiplexed data to the gNB 200. Instead of the RRC connection resume request message, the UE 100 can also multiplex an RRC Early Data Request message being a message for Control Plane-Early Data Transfer (CP-EDT) and uplink data and can transmit the multiplexed data to the gNB 200.

Note that, as an option, the PUR also allows transmission of downlink data. In other words, after the RRC connection resume request message, downlink data is multiplexed into the RRC Connection Release message (or RRC Early Data Complete message) transmitted from the gNB 200, and thus the UE 100 in the RRC idle state receives downlink data together with the RRC connection release message.

When the UE 100 in the RRC idle state transmits data too large to be transmitted using the PUR resource, the UE 100 transmits the RRC connection resume request message and a segment of the data to the gNB 200 by using the PUR resource. Then, the gNB 200 executes a connection resume procedure with the UE 100, and the UE 100 transitions to the RRC connected state and transmits uplink data previously unsuccessfully transmitted.

The processing described above is an example of a case in which the UE 100 is in the RRC idle state. In the present embodiment, PUR transmission can also be performed when the UE 100 is in the RRC inactive state. In the example described above, the processing can be performed, with the RRC idle state being replaced with the RRC inactive state.

### SDT

In the present embodiment, EDT and PUR may be collectively referred to as Small Data Transmission (SDT). Data transmitted using SDT is data having a predetermined size or smaller (or small data or a small piece of data), and has a size that can be transmitted in data transmitted using EDT or PUR.

Note that data transmission using EDT may be hereinafter referred to as EDT transmission (first data transmission), data transmission using PUR may be hereinafter referred to as PUR transmission (second data transmission), and data transmission using SDT may be hereinafter referred to as SDT transmission.

### EXAMPLE 1

In a communication control method in Example 1, the UE 100 in the RRC connected state transmits preference information to the gNB 200. The preference information here is preference information indicating that the UE 100 in the RRC inactive state desires to perform transmission of data by using the message of the random access procedure and/or transmission of data by using the preconfigured uplink resource. Such preference information may be hereinafter referred to as SDT preference information. With the UE 100 transmitting the SDT preference information to the gNB 200, the gNB 200 can recognize information used for the PUR transmission or the EDT transmission and the like at the time of causing the UE 100 to transition to the RRC inactive state, and efficiency of subsequent processing can thus be enhanced.

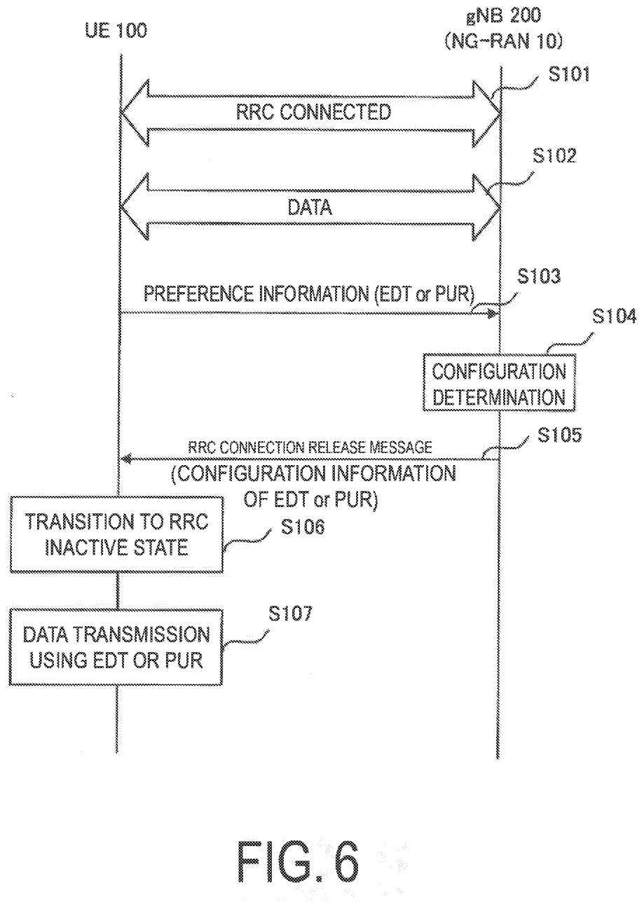

An operation example in Example 1 will be described. FIG. 6 is a diagram illustrating an operation example in Example 1.

As illustrated in FIG. 6, in Step S101, the UE 100 is in the RRC connected state with the gNB 200.

In Step S102, the UE 100 transmits data to the gNB 200, and receives data transmitted from the gNB 200.

In Step S103, when the UE 100 desires to perform data transmission by using EDT or PUR, the UE 100 transmits the SDT preference information to the gNB 200. For example, when the controller 130 determines that such a desire as described above is present, the controller 130 generates the SDT preference information and transmits the SDT preference information to the gNB 200 via the transmitter 120.

The SDT preference information may be included in a UE Assistance Information message and may be transmitted, for example. The UE assistance information message is, for example, a message for the UE 100 in the RRC connected state to give notification of a desire or a request related to a configuration of RRC connection of the UE 100. The UE assistance information message includes, for example, preference of the UE 100 with regard to power saving, and Semi Persistent Scheduling (SPS) assistance information.

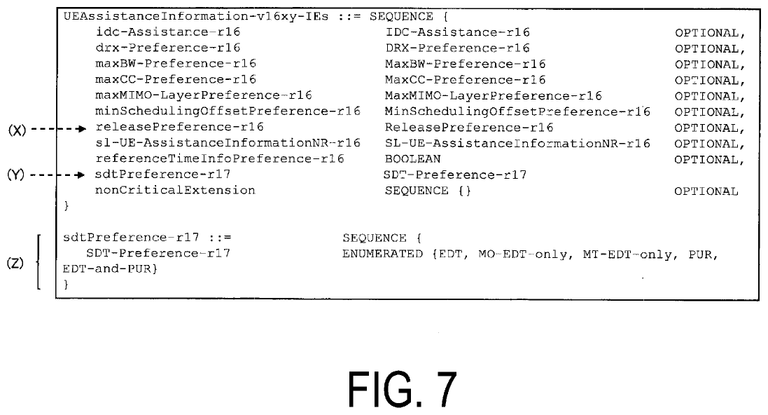

FIG. 7 is a diagram illustrating an example of the UE assistance information message including the SDT preference information. As illustrated in FIG. 7, the UE assistance information message includes an information element (“sdtPreference-r17”, (Y) in FIG. 7) indicating that the SDT preference information is included in the UE assistance information message. The information element includes items of “EDT”, “MO-EDT-only”, “MT-EDT-only”, “PUR”, and “EDT-and-PUR” ((Z) in FIG. 7).

In other words, when the UE 100 desires to perform EDT, the UE 100 includes “EDT” in the information element indicated in (Y) of FIG. 7. When the UE 100 desires to perform MO-EDT (only), the UE 100 includes “MO-EDT-Only” in (Y) of FIG. 7, when the UE 100 desires to perform MT-EDT (only), the UE 100 includes “MT-EDT-Only” therein, and when the UE 100 desires to perform PUR, the UE 100 includes “PUR” therein. When the UE 100 desires to perform EDT and PUR, the UE 100 includes “EDT-and-PUR” in the information element indicated in (Y) of FIG. 7. When the UE 100 desires to perform EDT or PUR, this is indicated by an information element of “EDT-or-PUR”, or only “SDT configuration desired” may be included in the information element to be notified.

Note that the SDT preference information may be linked to an information element “releasePreference-r16” of the UE assistance information message illustrated in FIG. 7. “releasePreference-r16” is, for example, an information element used when the UE 100 desires release of RRC connection. “releasePreference-r16” includes elements of “Idle”, “Inactive”, and “Connected”. For example, the SDT preference information may be linked as follows.

In other words, (only) when “Inactive” is included in “releasePreference-r16”, the UE 100 may notify of (or transmit) the SDT preference information. Alternatively, when “Idle” is included in “releasePreference-r16”, the UE 100 may be configured not to transmit the SDT preference information. Alternatively, even when the UE 100 includes the SDT preference information in a UE assistance information message including “Idle” in “releasePreference-r16” and transmits the UE assistance information message, the gNB 200 may ignore the SDT preference information included in the UE assistance information message.

The above example describes an example in which the UE assistance information message includes the SDT preference information. The SDT preference information may be included in another (RRC) message.

The UE 100 may transmit packet information to the gNB 200 together with the SDT preference information. The packet information may include, for example, the size of the packet including data transmitted by the UE 100 by using SDT, periodicity of the packet, and/or the occurrence timing. The packet information may include a service type. The service type includes, for example, “delay tolerant”, “mission critical”, “normal data” (data), and “signalling”. Such a service type may be represented by Quality of Service (QoS), a 5G QoS Indicator (5QI), or Network Slice Selection Assistance Information (NSSAI). In the UE 100, information related to such a service type may be notified from a Non Access Stratum (NAS) layer or an application layer. Alternatively, the service type may be estimated in an Access Stratum (AS) layer, based on a transmission history of the UE 100 and the like.

The UE 100 may add preference information regarding frequency (hereinafter referred to as “frequency preference information”) to the SDT preference information and then transmit the SDT preference information. The frequency preference information is, for example, preference information related to a frequency that the UE 100 desires to use in data transmission (or SDT transmission). The frequency preference information may include, for example, a carrier number, a Bandwidth Part (BWP), or a bandwidth that the UE 100 desires.

The UE 100 may add information on whether to desire multi-cell PUR to the SDT preference information and then transmit the SDT preference information to the gNB 200. Multi-cell PUR will be described in Example 2. The UE 100 may include information related to a movement state of the UE 100 in the SDT preference information and then transmit the SDT preference information. Such information related to the movement state may include information related to the current movement state (geographically fixed, low speed movement, or high speed movement) and include a prediction value of future movement of the UE 100. The UE 100 may include information on whether to remain in the current serving cell (or the serving gNB 200) in the future in the SDT preference information and then transmit the SDT preference information.

The SDT preference information, the additional information, the UE assistance information message, and the like described above may be generated in the controller 130 and then transmitted to the gNB 200 via the transmitter 120.

Referring back to FIG. 6, when the gNB 200 receives the SDT preference information, in Step S104, the gNB 200 performs configuration determination. In other words, the gNB 200 performs configuration for the UE 100, based on the SDT preference information. For example, the gNB 200 performs the following configuration.

In other words, for SDT (that is, EDT or PUR transmission), the gNB 200 may configure ON/OFF configuration of Robust Header Compression (ROHC) being a header compression technology in the PDCP layer, a Next Hop Changing Counter (NCC)) value used in encryption of data and the like, or the like. The gNB 200 may configure the uplink radio resource of an appropriate size. Such a radio resource is used as the PUR resource in particular. In addition to the PUR resource, the gNB 200 may configure information used when the UE 100 performs transmission by using SDT. The configuration determination as described above may be performed in the controller 230.

In Step S105, the gNB 200 transmits the RRC connection release message to the UE 100. In this case, the gNB 200 includes the information configured in Step S104 in the RRC connection release message and then transmits the RRC connection release message. The RRC connection release message may include “Suspend Config.”. In other words, the RRC connection release message may include configuration information for SDT transmission used when the UE 100 in the RRC inactive state performs the SDT transmission. In this case, for example, the configuration information may include both of pieces of configuration information for a case in which EDT is performed and a case in which PUR is performed in the UE 100. In the UE 100 that has received both of the pieces of configuration information, for example, the following processing may be performed.

In other words, in accordance with a predetermined condition, the UE 100 may determine to execute either EDT or PUR and execute EDT or PUR by using the configuration information regarding the determined EDT or PUR. The predetermined condition includes, for example, A) the UE 100 executes SDT notified in the SDT preference information, B) when the UE 100 exists in the same cell, the UE 100 executes PUR, and when the UE 100 moves to another cell, the UE 100 executes EDT, C) when Timing Advance (TA) is valid, the UE 100 executes PUR, and when TA is disabled, the UE 100 executes EDT, D) determination is made depending on a radio state (a threshold value may be configured from the gNB 200), or E) determination depends on implementation of the UE 100.

Note that the “radio state” in D) above refers to received signal quality, examples of which include Reference Signal Received Power (RSRP), Reference Signal Received Quality (RSRQ), and a Signal to Interference plus Noise Ratio (SINR).

When the UE 100 receives both of the pieces of configuration information for EDT and PUR, the UE 100 may preferentially execute the PUR transmission. For example, when the UE 100 can execute the PUR transmission (the UE 100 may perform the determination according to B), C), or D)), the UE 100 executes the PUR transmission. When the UE 100 cannot execute the PUR transmission, the UE 100 executes EDT.

Alternatively, when the UE 100 having received both of the pieces of configuration information for EDT and PUR executes the PUR transmission and then the PUR transmission fails, the UE 100 may execute EDT. For example, when the UE 100 attempts to transmit a packet by using PUR but receives no response from the gNB 200, the UE 100 performs a fallback to execute EDT and transmits the packet in Msg3 or MsgA.

Alternatively, when the UE 100 receives both of the pieces of configuration information for EDT and PUR and either the EDT transmission or the PUR transmission is successful, the UE 100 may discard the EDT configuration and/or the PUR configuration.

Note that, in the following, description will be given based on the assumption that the UE 100 executes EDT or PUR in consideration of the predetermined condition.

For example, the controller 230 may generate the RRC connection release message and then transmit the RRC connection release message via the transmitter 210. The determination, execution, and the like as described above may be performed by the controller 230 in the gNB 200 and by the controller 130 in the UE 100.

In Step S106, the UE 100 transitions to the RRC inactive state. For example, when the controller 130 receives the RRC connection release message via the receiver 110, the controller 130 causes the UE 100 to transition to the RRC inactive state in accordance with information included in the message.

The RRC inactive state is, for example, a state in which connection between the RRC of the UE 100 and the RRC of the gNB 200 is suspended. In the RRC inactive state, a UE context is stored in the UE 100, the gNB 200, and a network. Thus, the UE 100 can reduce the number of signals used for a procedure for recovering from the RRC inactive state to the RRC connected state. The UE 100 in the RRC inactive state is the same as and/or similar to that in the RRC idle state, and thus allows power saving for the UE 100. The RRC inactive state allows, for example, an Internet Of Things (IoT) scenarios to be taken into consideration, and thus the RRC connection state appropriate for SDT communication can be configured.

In Step S107, the UE 100 performs data transmission by using SDT in accordance with the configuration performed by the gNB 200 (Step S105).

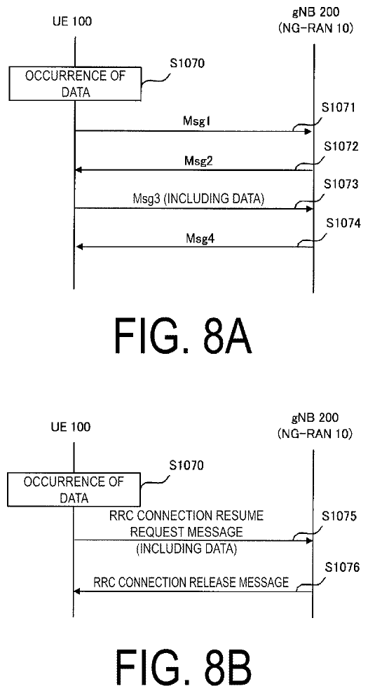

FIG. 8A is a diagram illustrating an operation example of data transmission by using EDT.

In Step S1070, when data occurs (S1070), the UE 100 transmits and receives a series of messages of the random access procedure (Steps S1071 to S1074).

In other words, in Step S1071, the UE 100 transmits Msg1 (random access preamble) to the gNB 200. Note that “Msg” stands for a message.

In Step S1072, the gNB 200 transmits, to the UE 100, Msg2 (random access response) including scheduling information indicating the uplink resource allocated to the UE 100.

In Step S1073, the UE 100 transmits Msg3 to the gNB 200 in accordance with the scheduling information. Msg3 is, for example, an RRC Connection Resume Request message. In the MAC layer, the UE 100 multiplexes the RRC connection resume request message and data (DTCH) into one MAC PDU and then transmits the MAC PDU. In this manner, uplink EDT is performed. Alternatively, in the RRC layer, the UE 100 may encapsulate the data in the RRC connection resume request message.

In Step S1074, the gNB 200 transmits Msg4 to the UE 100. Msg4 is, for example, an RRC Connection Release message. The gNB 200 may multiplex the downlink data into Msg4 or encapsulate the downlink data in Msg4 and then transmit the Msg4. In this manner, downlink EDT is performed. When the UE 100 receives the RRC connection release message, the UE 100 completes the random access procedure while maintaining the RRC inactive state.

For example, the controller 130 may perform generation of Msg1 and Msg3, multiplexing of the data, and the like, and the controller 230 may perform generation of Msg2 and Msg4, multiplexing of the data, and the like. In a case of 2-step RACH, for example, the controller 130 may perform generation of MsgA and the like, and the controller 230 may perform generation of MsgB and the like.

FIG. 8B is a diagram illustrating an example of data transmission by using PUR.

In Step S1070, when data occurs, in Step S1075, for example, the UE 100 transmits the RRC Connection Resume Request message to the gNB 200 by using configured PUR resource. In a manner the same as and/or similar to the case of EDT, in the MAC layer, the UE 100 multiplexes the RRC connection resume request message and data into one MAC PDU and then transmits the MAC PDU. In this manner, uplink PUR is performed. Alternatively, in the RRC layer, the UE 100 may encapsulate the data in the RRC connection resume request message.

Note that, when the data is too large to be transmitted by using the PUR resource, the UE 100 transmits an RRC connection release request message and a segment of the user data to the gNB 200 by using the PUR resource. Then, a legacy RRC connection resume procedure is initiated, and after RRC connection, data transmission is performed.

In Step S1076, the gNB 200 transmits the RRC connection release message to the UE 100. In a manner the same as and/or similar to the case of EDT, the gNB 200 may multiplex the downlink data into the RRC connection release message or encapsulate the downlink data in the RRC connection release message and then transmit the RRC connection release message. In this manner, downlink PUR is performed.

Note that, in Example 1, both EDT and PUR can be performed as well. For example, after the procedure illustrated in FIG. 8A is performed, the procedure illustrated in FIG. 8B can be performed, and vice versa. For example, when “EDT-and-PUR” is included in the information element “sdtPreference-r17” of the UE assistance information message illustrated in FIG. 7, such a procedure may be performed.

### Example 1-1

Example 1-1 will be described. Example 1-1 is an example in which the gNB 200 that has received preference information associates the preference information with the UE context and then transmits the SDT preference information to a different gNB.

The UE 100 in the RRC inactive state can perform cell selection and cell reselection, in a manner the same as and/or similar to that in the RRC idle state. For example, the UE 100 can also select a cell of a different gNB from the gNB 200 to which the UE 100 has transmitted the SDT preference information and then transmit data to such a different gNB. In this case, when the different gNB does not include the SDT preference information of the UE 100, the UE 100 transmits the SDT preference information to the different gNB again. This does not enable power saving for the UE 100, and efficiency of processing cannot be enhanced either.

In view of the above, in Example 1-1, the gNB 200 that has received the preference information transmits the received SDT preference information to the different gNB and thereby enables power saving for the UE 100 and enhancement of efficiency of processing.

Specifically, two cases are considered, i.e., a case of using a UE context retrieval (UE Context Retrival) message of an Xn interface and a case of using a Handover Request message.

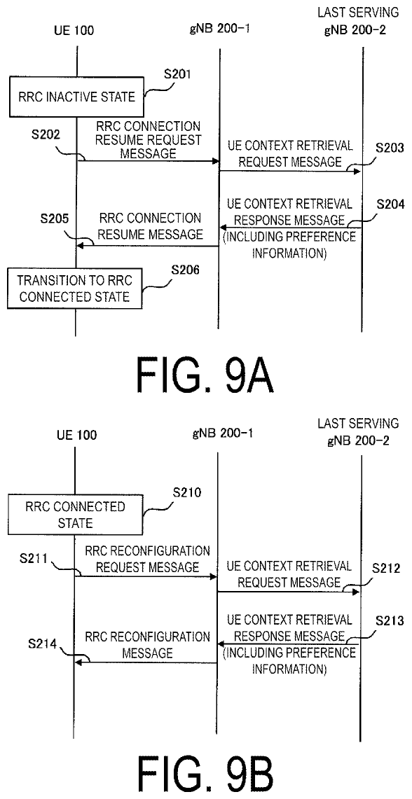

FIGS. 9A and 9B illustrate operation examples when the UE context retrieval message is used. Of the figures, FIG. 9A is an example of a procedure of the UE 100 triggered transition (UE triggered transition from RRC_INACTIVE to RRC CONNECTED) from the RRC inactive state to the RRC connected state. In contrast, FIG. 9B is an example of an RRC_Reestablishment procedure.

In the example of FIG. 9A, the gNB that has received the SDT preference information from the UE 100 is illustrated as a last serving gNB 200-2.

The UE 100 in the RRC inactive state in Step S201 transmits, in Step S202, the RRC connection resume request message to a gNB 200-1 different from the gNB 200-2 to which the UE 100 has transmitted the SDT preference information. The message includes an Inactive-Radio Network Temporary Identifier (I-RNTI) supplied from the last serving gNB 200-2 to the UE 100. In Step S203, when the gNB 200-1 successfully decodes identification information of a gNB included in the I-RNTI, the gNB 200-1 transmits a UE context retrieval request (Retrieve UE Context Request) message to the gNB, i.e., the last serving gNB 200-2. In Step S204, the last serving gNB 200-2 transmits a UE context retrieval response (Retrieve UE Context Response) message to the gNB 200-1. The UE context retrieval response message includes the SDT preference information received from the UE 100 as well as UE context data. Thus, the gNB 200-1 that has received an RRC connection resume request from the UE 100 can retrieve the SDT preference information from the last serving gNB 200-2. Then, in Steps S205 and S206, a series of transition procedures are performed. Note that, in the example of FIG. 9A, the RRC connection release message may be transmitted in addition to the RRC connection resume message in Step S205.

In a manner the same as and/or similar to FIG. 9A, in the example of FIG. 9B as well, the last serving gNB 200-2 is a gNB that has received the SDT preference information from the UE 100.

The UE 100 in the RRC connected state in Step S210 transmits an RRC reconfiguration request (RRC Reestablishment Request) message to the gNB 200-1 in Step S211. The RRC reconfiguration request message includes identification information (a Physical Cell Identifier (PCI) and a Cell-RNTI (C-RNTI)) of the UE. In Step S212, when the UE context cannot be locally used, the gNB 200-1 transmits a UE context retrieval request (Retrieve UE Context Request) message to the last serving gNB 200-2. In Step S213, the last serving gNB 200-2 transmits a UE context retrieval response (Retrieve UE Context Response) message to the gNB 200-1. The UE context retrieval response message includes the SDT preference information retrieved from the UE 100 as well as the UE context of the UE 100. Then, in Step S214, a series of reconfiguration procedures are performed.

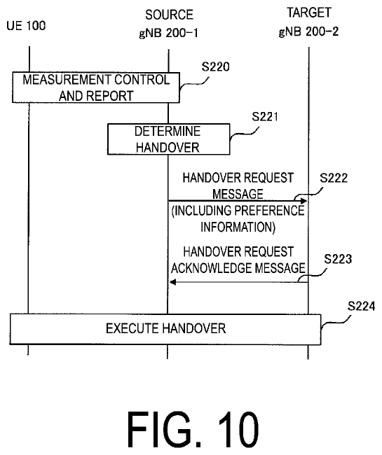

FIG. 10 is a diagram illustrating an operation example in which the SDT preference information is transmitted by using the handover request message. In the example of FIG. 10, a source gNB 200-1 is a gNB that has received the SDT preference information from the UE 100.

In Step S220, the UE 100 and the source gNB 200-1 perform measurement control and measurement report. In Step S221, the source gNB 200-1 determines to perform handover. In Step S222, the source gNB 200-1 transmits a handover request (HO Request) message to a target gNB 200-2 (S222). In this case, the source gNB 200-1 includes the SDT preference information received from the UE 100 as well as the UE context of the UE 100 in the handover request message and then transmits the handover request message to the target gNB 200-2. Then, in Steps S223 and S224, a series of handover processing operations are performed.

A series of processing operations illustrated in FIGS. 9A, 9B and 10 may be, for example, performed in the controller 230, and messages related to the series of processing operations may be transmitted to another gNB via the backhaul communicator 240.

### EXAMPLE 2

Example 2 is an example in which PUR is supported in a plurality of cells. Such PUR may be referred to as “multi-cell PUR”.

In current 3GPP, when the UE 100 receives PUR configuration from the base station in a certain cell and the UE 100 accesses the base station in another cell different from the certain cell, the PUR Configuration is released at the UE 100 and the (ng-)eNB (3GPP TS 36.300 V16.2.0 (2020 July)).

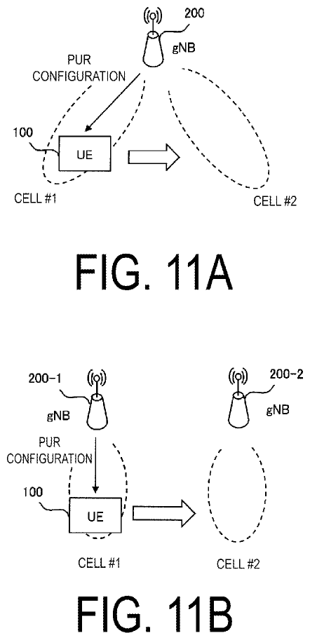

FIGS. 11A and 11B are diagrams for illustrating examples of such situations. Of the figures, FIG. 11A is an example of a case in which one gNB 200 includes two cells, and FIG. 11B is an example of a case in which each of the gNBs 200-1 and 200-2 includes one cell. In both of the cases, the UE 100 transmits, in a cell #1, the PUR Configuration Request message to the gNB 200 or the gNB 200-1 and receives a PUR Configuration message from the gNB 200 or the gNB 200-1. Then, as illustrated in FIGS. 11A and 11B, when the UE 100 moves to a cell #2 and accesses, in the cell #2, to the gNB 200 or the gNB 200-2, the PUR configuration included in the PUR configuration message is released.

Example 2 is an example in which the PUR configuration is supported in a plurality of cells (or “multi-cell”, which may be hereinafter referred to as “multi-cell”). In other words, in multi-cell PUR, the configuration information used when data is transmitted by using the preconfigured uplink radio resource can be used in a plurality of cells. With this, even when the UE 100 moves to another cell other than the cell in which the PUR configuration message is received, the UE 100 can perform data transmission by using PUR in the other cell by using the PUR configuration included in the PUR configuration message as it is. Thus, as compared to a case in which the UE 100 performs a series of procedures related to the PUR configuration every time the UE 100 moves between the cells, power consumption can be reduced, and efficiency of processing can be enhanced in the network as well.

In Example 2, in order to implement multi-cell PUR, an area in which the PUR configuration is valid (which may be hereinafter referred to as a “PUR area”) is configured.

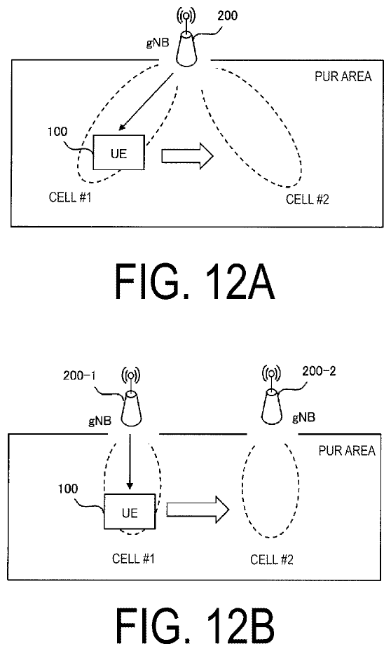

FIGS. 12A and 12B are diagrams illustrating examples of the PUR area. The example of FIG. 12A is an example in which two cells #1 and #2 are present in one gNB 200, and the PUR area is configured for the two cells #1 and #2.

The example of FIG. 12B is an example in which cells #1 and #2 are respectively present in the two gNBs 200-1 and 200-2 on a one-to-one basis.

Both of the cases illustrate an example in which the UE 100 receives the PUR configuration in the cell #1 and moves to the cell #2. In both of the cases, the UE 100 can perform PUR transmission in the cell #2 by using the PUR configuration configured in the cell #1. In other words, the UE 100 can perform PUR transmission with the same PUR configuration in any of the cells in the PUR area. In this manner, information of the PUR area includes, for example, area information indicating an area in which the configuration information of PUR is valid in a plurality of cells, irrespective of when a plurality of cells are present in one gNB 200 or when a plurality of cells are configured by at least one cell being present in each of the plurality of gNBs 200-1 and 200-2.

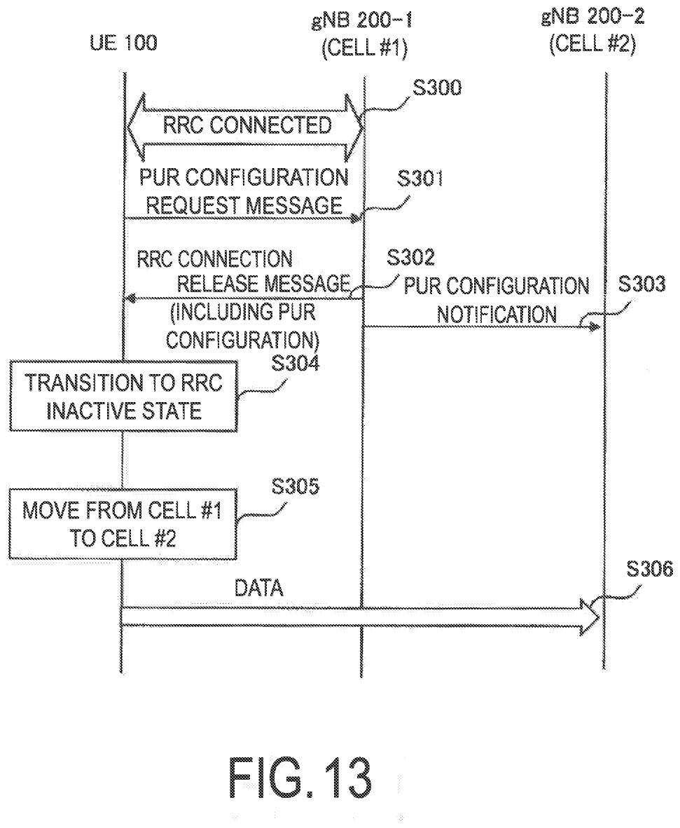

FIG. 13 is a diagram illustrating an operation example of Example 2. The example of FIG. 13 is an example of a case in which cells #1 and #2 are respectively present in the two gNBs 200-1 and 200-2 on a one-to-one basis.

As illustrated in FIG. 13, in Step S300, the UE 100 is in the RRC connected state with the gNB 200-1.

In Step S301, the UE 100 transmits the PUR Configuration Request message to the gNB 200-1.

In Step S302, the gNB 200-1 transmits the RRC Connection Release message including information related to PUR Configuration to the UE 100. In this case, the gNB 200-1 includes information of the PUR area in the information related to the PUR configuration and then transmits the information of the PUR area to the UE 100. Specifically, the information of the PUR area includes the following, for example.

In other words, the information of the PUR area may be information including a list of cells in which the PUR configuration is valid. For example, in the example of FIG. 12A, the information of the PUR area is information including a list of “cell #1” and “cell #2”.

Alternatively, the information of the PUR area may be an identification (ID) for identifying the PUR area. For such an ID, it is assumed that correspondence between the PUR area and the ID is defined in advance and the information regarding the correspondence between the PUR area and the ID is shared between the UE 100 and the gNBs 200-1 as well as 200-2. For example, when the PUR area illustrated in FIG. 12A has an ID “PUR area #1”, this “PUR area #1” corresponds to the information of the PUR area.

Alternatively, the PUR area may be the same as a RAN-based Notification Area (RNA). In this case, for example, such definition regarding the RNA is made and shared between the UE 100 and the gNBs 200-1 as well as 200-2. In this case, the gNB 200-1 may not explicitly configure the PUR area, and the information of the PUR area may not be included in the PUR configuration. Alternatively, the gNB 200-1 may notify the UE 100 that the PUR area is the same as the RNA.

Note that, regarding the PUR configuration, configuration may be different for each cell except for the information of the PUR area. For example, in the example of FIG. 12A, in the cell #1 and the cell #2, the configuration information may be different for each cell. In such a case, the gNB 200-1 transmits, to the UE 100, the RRC connection release message including information related to the PUR configuration different for each cell.

Referring back to FIG. 13, in Step S303, the gNB 200-1 may transmit a PUR configuration notification message including the PUR configuration to the gNB 200-2. For example, the gNB 200-1 may transmit the PUR configuration notification message to the gNB 200-2 by using an Xn interface or transmit the PUR configuration notification message to the gNB 200-2 via the AMFs 300-1 and 300-2 by using an NG interface. The gNB 200-2 may return a response message for the PUR configuration notification message to the gNB 200-1. The response message may include information on whether the PUR configuration notification message of Step S303 can be granted. In other words, if the PUR configuration notification message can be granted, the gNB 200-2 returns a positive response (ACK) message, whereas if the PUR configuration notification message cannot be granted, the gNB 200-2 returns a negative response (NACK) message.

Note that, in the example of FIG. 13, the gNB 200-1 transmits the PUR configuration notification message after transmitting the RRC connection release message. However, the gNB 200-1 may transmit the PUR configuration notification message to the gNB 200-2 before transmitting the RRC connection release message (or before performing the PUR configuration).

In Step S304, the UE 100 transitions to the RRC inactive state, and in Step S305, the UE 100 moves from the cell #1 to the cell #2. Then, in Step S306, the UE 100 performs PUR transmission to the gNB 200-2 including the cell #2 in accordance with the PUR configuration. Specifically, for example, the following operation is performed.

In other words, the UE 100 determines whether the cell in which the UE 100 exists is a cell included in the PUR area, based on the information of the PUR area included in the PUR configuration. Then, when the UE 100 determines that the cell is a cell in a valid area included in the information of the PUR area, in Step S306, the UE 100 performs the PUR transmission. In contrast, when the UE 100 determines that the area in which the UE 100 exists is not the cell included in the PUR area, the UE 100 does not perform the PUR transmission. In this case, the UE 100 may discard the information related to the PUR configuration received in Step S302.

Note that the above example provides description that the information related to the PUR area is included in the information related to the PUR configuration and is transmitted to the UE 100 by using the RRC connection release message. For example, the gNBs 200-1 and 200-2 may broadcast the information related to the PUR area, such as a PUR area ID, by using a System Information Block (SIB). Alternatively, the gNBs 200-1 and 200-2 may broadcast information indicating support of multi-cell PUR, by using an SIB.

In the above example, when the cell #1 and the cell #2 are neighboring cells, the gNB 200-1 may broadcast a Timing Advance (TA) value applied to the neighboring cell #2. For example, when the UE 100 accesses to the gNB 200-2 (or the gNB 200-1) in the cell #2, the UE 100 may correct timing by using such a TA value and may perform PUR transmission in Step S306. Alternatively, the gNB 200-1 may broadcast information regarding applying, also in the cell #2, the TA value applied by the UE 100 in cell #1 as it is or information regarding applying, also in the cell #2, TA=0 (or an allowable TA value).

The above example is an operation example taking FIG. 12B as an example but is also applicable even when two cells are present in one gNB 200 as illustrated in FIG. 12A, for example. The above example is also applicable even when three or more cells are present in one gNB 200. The above example is also applicable even when a plurality of cells are present in each of the gNBs 200-1 and 200-2.

### EXAMPLE 3

Example 3 will be described. Example 3 is an example in which SDT transmission is performed by using at least one selected from the group consisting of carrier aggregation (which may be hereinafter referred to as “CA”), dual connectivity (which may be hereinafter referred to as “DC”), and PDCP duplication.

In 5G, various use cases are assumed, such as ultra high speed (Enhanced Mobile Broad Band (eMBB)), multiple simultaneous connection (Massive Machine Type Communication (mMTC)), and low latency and high reliability (Ultra-Reliable and Low Latency Communications (URLLC)). In contrast, in SDT, for example, data transmission with a data size other than a predetermined size is performed, and use cases in the field of IoT using various sensors are assumed. However, even in SDT, the use of CA, DC, or PDCP duplication can allow SDT to meet requirements of the various use cases assumed in 5G, such as the requirement of low latency and high reliability.

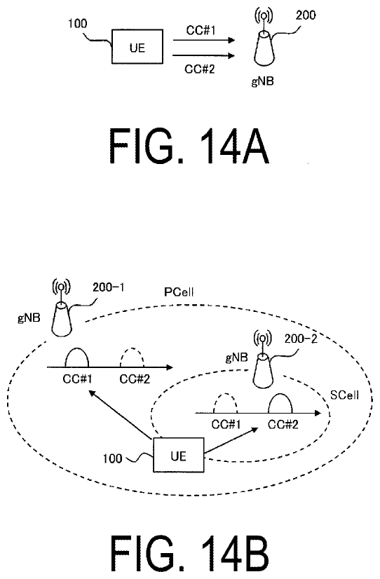

FIGS. 14A and 14B are diagrams illustrating examples of CA. CA refers to, for example, wireless communication by using a plurality of frequency bands.

The example of FIG. 14A illustrates an example in which the UE 100 performs data transmission to one gNB 200 by using Component Carrier (CC) #1 and CC #2. A cell may be configured for each CC. In this case, the UE 100 performs wireless communication with the gNB 200 by using the CC #1 in a cell #1 and the CC #2 in a cell #2.

FIG. 14B is an example in which the gNB 200-1 includes a Primary Cell (PCell) and the gNB 200-2 includes a Secondary Cell (SCell). The example illustrates an example in which the UE 100 performs wireless communication with the gNB 200-1 by using the CC #1 in the PCell and performs wireless communication with the gNB 200-2 by using the CC #2 in the SCell.

In both of the cases of FIGS. 14A and 14B, in Example 3, the UE 100 can perform the data transmission by using SDT. Details will be described below.

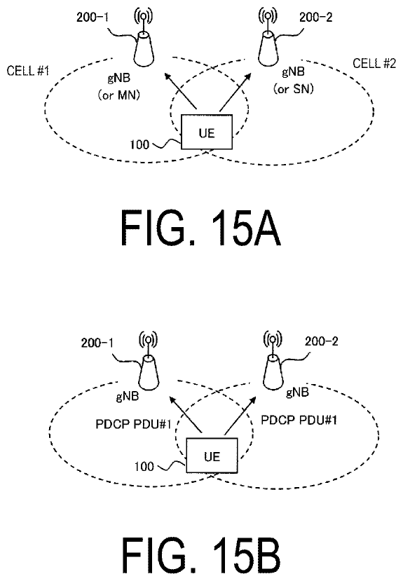

FIG. 15A is a diagram illustrating an example of DC. For example, in DC, the UE 100 simultaneously performs wireless communication with two gNBs 200-1 and 200-2. The gNB 200-1 may be a Master Node (MN) that maintains connection of communication between the UE 100 and the network, and the gNB 200-2 may be a Secondary Node (SN) that provides a radio resource for the UE 100. In this case, a group including a serving cell (cell #1) of the MeNB (gNB 200-1) is a master cell group (MCG), and a group including a serving cell (cell #2) of the SeNB (gNB 200-2) is a secondary cell group (SCG). Note that, the example of FIG. 15A includes two gNBs but may include three or more gNBs.

FIG. 15B is a diagram illustrating an example of PDCP duplication. When a radio bearer for PDCP duplication is established by the RRC, at least one secondary RLC entity is added to the radio bearer in order to handle a duplicated PDCP PDU. A logical channel corresponding to a primary RLC entity is a primary logical channel (Primary LCH), and a logical channel corresponding to a secondary RLC entity is a secondary logical channel (Secondary LCH). The same PDCP PDU is transmitted a plurality of times owing to duplication in the PDCP, and thus the reliability is enhanced. The secondary logical channel can be activated or deactivated by using a MAC Control Element (MAC CE), which allows for control of duplication or no duplication of the PDCP. The example of FIG. 15B illustrates an example in which the UE 100 transmits the same PDCP PDU #1 to two gNBs 200-1 and 200-2.

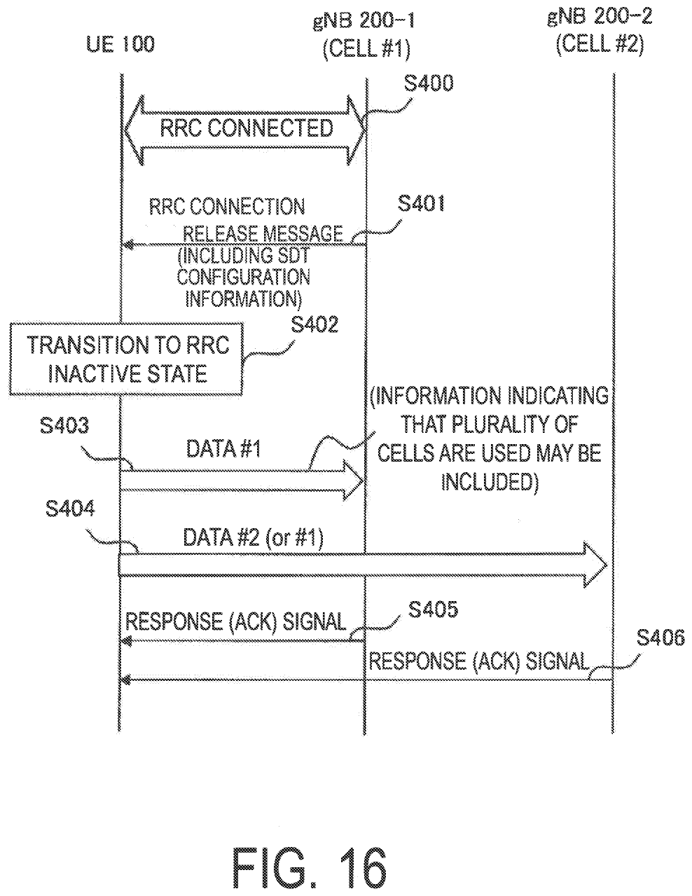

FIG. 16 is a diagram illustrating an operation example of Example 3. The example illustrated in FIG. 16 is an example in which the gNB 200-1 includes the cell #1 and the gNB 200-2 includes the cell #2. This is an example in which the UE 100 performs the SDT transmission by using at least one selected from the group consisting of CA, DC, and PDCP duplication.

As illustrated in FIG. 16, in Step S400, the UE 100 is in the RRC connected state with the gNB 200-1. In Step S401, the gNB 200-1 transmits the RRC Connection Release message to the UE 100. In this case, the gNB 200-1 transmits the RRC connection release message including configuration information (which may be hereinafter referred to as “SDT configuration information”) used for the SDT transmission. Note that the gNB 200-1 may include the SDT configuration information in another message and then transmit the message. The SDT configuration information includes the following information, for example.

In other words, the SDT configuration information may include PUR configuration information for each cell. Specifically, the PUR configuration information may include, for each cell, a radio resource used for the PUR transmission, periodicity and/or duration of the PUR transmission, a PUR-RNTI being identification information of each PUR, and an RSRP threshold value used for determining whether to perform the PUR transmission. In this case, the PUR configuration information may be in a list form for each cell. One example thereof is a case in which the radio resource and the like in cell #1 and the radio resource and the like in cell #2 are in a list form.

The SDT configuration information may include EDT configuration information for each cell. Specifically, an ROHC configuration or an NCC value may be included for each cell. In this case as well, a list form may be employed for each cell.

The SDT configuration information may include configuration information associated with a cell. Specifically, the configuration information includes configuration information regarding which cell is used to perform CA when CA is performed in the UE 100 or configuration information regarding which cell is used to perform DC when DC is performed in the UE 100. The cells to be used are two cells in the case of FIG. 14B or 15A but may be three or more cells.

The SDT configuration information may include a corresponding bearer ID (or a logical channel ID (LCID)). For example, in PDCP duplication, two channels (or two bearers), namely the primary logical channel and the secondary logical channel, are established, and the SDT configuration information may include respective IDs of the logical channels (or respective IDs of the bearers) established in this manner.

The SDT configuration information may include configuration information on whether to perform PDCP duplication. In this case, when a bearer (logical channel) used for PDCP duplication configuration is already present, the SDT configuration information may refer to this configuration. In other words, the SDT configuration information may refer to a bearer ID or a logical channel ID used for PDCP duplication, or this fact may be included in the SDT configuration information.

The SDT configuration information may include information related to the PUR area described in Example 2. For example, when the PUR area includes a plurality of cells (the plurality of cells in FIGS. 14A, 14B, 15A, and 15B), the UE 100 can also use the same PUR configuration in the plurality of cells and perform the PUR transmission by using at least one selected from the group consisting of CA, DC, and PDCP duplication.

The gNB 200-1 may generate the SDT configuration information based on the preference information described in Example 1 and then transmit the SDT configuration information to the UE 100.

The SDT configuration information as described above may be generated in the controller 230 and then transmitted from the transmitter 210.

In Step S402, the UE 100 transitions to the RRC inactive state.

In Steps S403 and S404, the UE 100 executes SDT using a plurality of cells. Note that, in FIG. 16, Steps S403 and S404 may be performed at the same timing. In Steps S403 and S404, the same data may be transmitted, or different pieces of data may be transmitted. When the same data is transmitted, PDCP duplication is used, but PDCP duplication and CA or DC may be combined together. When different pieces of data are transmitted, CA or DC may be used, or CA and DC may be combined together.

In Step S403, the UE 100 may transmit the following information to the gNB 200-1, for example, other than the data.

In other words, in the cell #1 (the MCG or the PCell), the UE 100 may transmit information indicating that a plurality of cells are used. This allows such information to be used for synthesis of data in the gNB 200 that has received different pieces of data in CA or DC, for example.

The information indicating that a plurality of cells are used may include, for example, IDs of the cells being used, bearer IDs, logical channel IDs (LCIDs), an entry number of the SDT configuration information. In this case, the UE 100 may include the information indicating that a plurality of cells are used in data #1 and then transmit the data #1 or may include the information indicating that a plurality of cells are used separately in signalling (control signal) and then transmit the signalling. Alternatively, the UE 100 may transmit the information indicating that a plurality of cells are used by using the RRC or transmit the information indicating that a plurality of cells are used by using the MAC CE.

The UE 100 may transmit information on whether the PDCP duplication is performed.

Note that the example of FIG. 16 illustrates an example in which the UE 100 performs the SDT transmission in Steps S403 and S404 without especially making a determination to perform the SDT transmission, after transitioning to the RRC inactive state. For example, the UE 100 may perform a specific determination and determine whether to perform SDT transmission.

For example, the UE 100 may determine whether to execute SDT using a plurality of cells (the cell #1 and the cell #2 in the example of FIG. 15A) or to execute SDT using a single cell (the cell #1 in the example of FIG. 15A) in the plurality of cells, based on a transmission data volume, a service type (delay sensitive or the like), a radio state between the UE 100 and the gNB 200-1 (or the gNB 200-2), and the like. For such a determination, the UE 100 may use a threshold value transmitted from the gNB 200-1.

The execution control of the SDT transmission and the generation of the information to be transmitted to the gNB 200-1 as described above in the UE 100 may be, for example, performed in the controller 130. Data, various pieces of information, and the like may be transmitted from the transmitter 120 in accordance with such control.

In Step S405, when the gNB 200-1 successfully receives the data (or the signalling) transmitted from the UE 100, the gNB 200-1 transmits a response (ACK) signal (or message) to the UE 100. In Step S406, when the gNB 200-2 also successfully receives the data (or the signalling), the gNB 200-2 transmits a response (ACK) signal. In both of the cases, when the gNBs 200-1 or 200-2 do not successfully receive the data (or the signalling), the gNBs 200-1 or 200-2 may transmit a response (NACK) signal (or message), respectively.

Note that, when the UE 100 performs PDCP duplication and receives a response (ACK) signal from (the gNB 200-1 (or 200-2) including) at least one cell out of the plurality of cells (the cells #1 and #2), the UE 100 determines that the corresponding data (or signalling) has been successfully transmitted. In contrast, when the UE 100 does not receive a response (ACK) from any of the cells (or the gNBs 200-1 and 200-2), the UE 100 determines that the data transmission has failed. When the UE 100 determines as described above, the UE 100 performs SDT again, or transmits the RRC connection resume request message to transition to the RRC connected state and attempts retransmission of the data.

### EXAMPLE 4

Example 4 will be described. Example 4 is an example in which the UE 100 that has failed in transmission by using SDT reports SDT Failure indicating the failure to the network.

For example, the following case is considered: transition to the RRC connected state is performed through transmission of the RRC connection resume message by using EDT or PUR. In this case, the network may not know whether the UE 100 has transmitted the RRC connection resume message after a procedure of SDT transmission has failed or the UE 100 has transmitted the RRC connection resume message without performing the procedure of the SDT transmission.

In this manner, when the network does not know the situation, collecting and analyzing information to implement Self Organizing Networks (SON) for autonomously optimizing the network may be difficult.

In view of the above, in Example 4, the UE 100 reports the SDT Failure to the network. With this, for example, the network can know that the SDT transmission has failed in the UE 100 and can collect such information or the like to thereby implement SON.

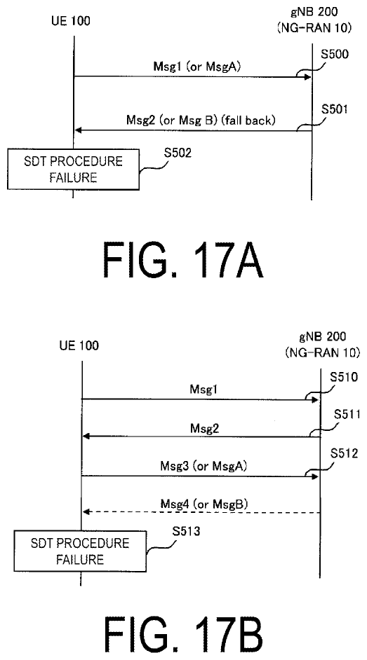

FIGS. 17A and 17B illustrate examples of patterns in which the procedure fails in a case of EDT. In both of FIGS. 17A and 17B, the UE 100 is in the RRC inactive state. In Example 4, the random access procedure includes a 4-step case and a 2-step case. Note that the series of procedures (for example, FIG. 8A or 8B) performed in the SDT transmission may be hereinafter referred to as an “SDT procedure”.

As illustrated in FIG. 17A, in a case of 4-step, in Step S500, the UE 100 transmits Msg1 to the gNB 200, and in Step S501, the gNB 200 transmits Msg2 including fall back information. The fall back information is, for example, information of a command to resume the random access procedure from the beginning. When the UE 100 receives the fall back information, in Step S502, the UE 100 confirms that the SDT procedure has failed. In Step S501, when the UE 100 cannot receive Msg2, the UE 100 can also confirm the failure in the SDT procedure in Step S502.

As illustrated in FIG. 17A, in a case of 2-step, in Step S500, the UE 100 transmits MsgA, and in Step S501, the gNB 200 transmits MsgB including the fall back information. In this case as well, in Step S502, the UE 100 confirms the failure in the SDT procedure. In Step S501, when the UE 100 cannot receive MsgB, the UE 100 also confirms the failure in the SDT procedure in Step S502.

FIG. 17B is an example of a case in which transmission and reception of Msg1 and Msg2 (Steps S510 and S511) are successful and transmission or reception of Msg3 fails. In other words, in a case of 4-step, when the UE 100 transmits Msg3 and data in Step S512 but cannot receive Msg4 from the gNB 200, in Step S513, the UE 100 confirms the failure in the SDT procedure. In a case of 2-step as well, when the UE 100 transmits MsgA and data in Step S512 but cannot receive MsgB, in Step S513, the UE 100 confirms the failure in the SDT procedure.

A failure in the SDT procedure in PUR, by contrast, corresponds to a case in which, for example, the UE 100 in the RRC inactive state transmits data to the gNB 200 by using the PUR resource but does not receive a response (for example, the RRC connection release message).

In this manner, in Example 4, when the UE 100 fails in the SDT procedure, the UE 100 records (or stores) information related to the failure.

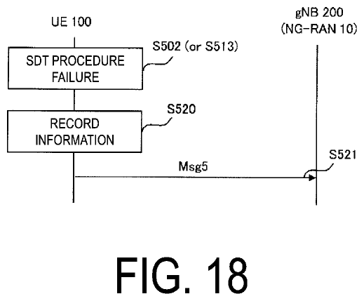

FIG. 18 is a diagram illustrating an operation example in Example 4. In Steps S502 (FIG. 17A) or S513 (FIG. 17B), when the UE 100 confirms an SDT procedure failure, in Step S520, the UE 100 records information of the failure. For example, the controller 130 generates information related to the failure and records the information in a memory in the controller 130. The information related to the failure includes the following, for example.

In other words, the information related to the failure may be information included in regular Minimization of Drive Tests (MDT). Information included in an MDT header includes a time stamp, latitude, longitude, and altitude, and a radio measurement result.

The information related to the failure may include a type of executed procedure. The type of executed procedure may be, for example, whether EDT is performed or PUR is performed, whether 4-step RACH is performed or 2-step RACH is performed, or the like. Note that, when 4-step RACH or 2-step RACH is indicated as the type of procedure, it is applicable even in a case of regular RACH, not EDT, irrespective of whether EDT is performed. In this case, for existing RACH Failure report, whether the procedure is 2-step can be distinguished.

The information related to the failure may be information of selected resource. Such information includes, for example, a time resource, a frequency resource, a Physical Resource Block (PRB), or a BWP.

The information related to the failure may be distinguishing information of the failure. The distinguishing information of the failure is, for example, information indicating which response is not returned. In the example of FIG. 17A, Msg2 or MsgB is not returned, and in this case, “Msg2” or “MsgB” corresponds to an example of the information. The distinguishing information of the failure may include a specific cause of the failure (or a special failure cause). One example thereof is cell reselection is performed in EDT or PUR, or the like.

The information related to the failure may be an executed System Frame Number (SFN) and/or subframe information. In other words, when data transmission fails, with which SFN or subframe the failure occurs, or the SFN or the subframe information used in the data transmission failed is represented by the information.

The information related to the failure may be the number of failures or a retry count identifier. For example, the number of failures may include the number of retries related to the same data transmission.

The information related to the failure may be data size information of failed data. The information related to the failure may be information on latency from occurrence of data to completion of data transmission.

Referring back to FIG. 18, in Step S521, the UE 100 transmits the information related to the failure to the gNB 200. As illustrated in FIG. 18, the UE 100 may include the information in Msg5 (an RRC Connection Setup Complete message or an RRC Connection Resume Complete message) and then transmit the Msg5. Alternatively, the UE 100 may transmit Msg5 including information indicating presence of a log to the gNB 200, and in response to a subsequent log retrieval request from the gNB 200, the UE 100 may transmit the information related to the failure to the gNB 200. For example, the message and the information as described above are generated in the controller 130 and are transmitted via the transmitter 120.

### Other Embodiments

A program causing a computer to execute each of the processing operations performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processing operations to be performed by the UE 100 or the gNB 200 may be integrated, and at least part of the UE 100 or the gNB 200 may be configured as a semiconductor integrated circuit (a chipset or an SoC).

Although an embodiment has been described in detail with reference to the drawings, a specific configuration is not limited to those described above, and various design modifications and the like can be made without departing from the gist. All of or a part of the examples can be combined together as long as the combination remains consistent.

1. A communication control method executed in a user equipment, the communication control method comprising:
performing one of a first transmission and a second transmission, the first transmission being a transmission where the user equipment in a Radio Resource Control (RRC) inactive state transmits data by using a message of a random access procedure, the second transmission being a transmission where the user equipment in the RRC inactive state transmits data by using a preconfigured radio resource, wherein
the performing comprises:
when both first configuration information for the first data transmission and second configuration information for the second data transmission are configured in the user equipment from the base station, determining whether an execution condition for the second data transmission is satisfied prior to the first data transmission; and
in response to determining that the execution condition for the second data transmission is satisfied, performing the second data transmission.

2. The communication control method according to claim 1, wherein
the performing further comprises:
in response to determining that the execution condition for the second data transmission is not satisfied, performing the first data transmission,
the communication control method further comprises:
in response to performing the first data transmission, clear the second configuration information configured in the user equipment.

3. A user equipment comprising:
a controller configured to perform one of a first transmission and a second transmission, the first transmission being a transmission where the user equipment in a Radio Resource Control (RRC) inactive state transmits data by using a message of a random access procedure, the second transmission being a transmission where the user equipment in the RRC inactive state transmits data by using a preconfigured radio resource, wherein
a controller is configured to
when both first configuration information for the first data transmission and second configuration information for the second data transmission are configured in the user equipment from the base station, determine whether an execution condition for the second data transmission is satisfied prior to the first data transmission, and
in response to determining that the execution condition for the second data transmission is satisfied, perform the second data transmission.

4. An apparatus controlling a user equipment, the apparatus comprising a processor and a memory coupled to the processor, the processor configured to
perform one of a first transmission and a second transmission, the first transmission being a transmission where the user equipment in a Radio Resource Control (RRC) inactive state transmits data by using a message of a random access procedure, the second transmission being a transmission where the user equipment in the RRC inactive state transmits data by using a preconfigured radio resource, wherein
the processor configured to
when both first configuration information for the first data transmission and second configuration information for the second data transmission are configured in the user equipment from the base station, determining whether an execution condition for the second data transmission is satisfied prior to the first data transmission; and
in response to determining that the execution condition for the second data transmission is satisfied, performing the second data transmission.
